(19) United States
(12) Patent Application Publication
(10) Pub. No.: US 2011/0300839 A1
(43) Pub. Date: Dec. 8, 2011

(54) SYSTEM FOR RECORDING A TELEPHONE CALL

(75) Inventor: Metodi Filipov, West Islip, NY (US)

(73) Assignee: BIANOR INC., Uniondale, NY (US)

(21) Appl. No.: 12/794,878

(22) Filed: Jun. 7, 2010

(51) Int. Cl. H04M 3/42

(52) U.S. Cl. 455/416; 379/202.01

(57) ABSTRACT

A system effective to generate information relating to a telephone call. The system comprises a mobile calling telephone, a called telephone, a memory, and a first processor in communication with the memory. The first processor is effective to receive a request from the calling mobile telephone to establish a telephone call with a called telephone. The first processor is further effective to establish a first telephone call between the first processor and the calling mobile telephone over a cellular network and establish a second telephone call between the first processor and the called telephone. The first processor is effective to bridge the first and second telephone calls through the first processor to produce a third telephone call; generate information relating to the third telephone call by the first processor; and send the information over a network to a second processor.

### BACKGROUND OF THE INVENTION

1. Field of the Invention

This disclosure relates to a system and method for recording a telephone call where the calling telephone is a mobile telephone.

2. Description of the Related Art

In cellular communications, a first calling mobile telephone sends information in an electromagnetic wave to a base station in a wireless network. The base station may forward the information to another base station and/or to a second called telephone. The called telephone may be a mobile telephone. The base station may also send the information to a public branch network exchange (PBX) so that telephones outside of the wireless network can communicate with telephones in the wireless network. This disclosure describes improvements over these prior art systems.

### SUMMARY OF THE INVENTION

One embodiment of the invention is a method for generating information relating to a telephone call. The method comprises receiving a request, by a processor, from a calling mobile telephone to establish a telephone call with a called telephone; and establishing, by the processor, a first telephone call between the processor and the calling mobile telephone over a cellular network. The method further comprises establishing, by the processor, a second telephone call between the processor and the called telephone; bridging, by the processor, the first and second telephone calls through the processor to produce a third telephone call; and generating information relating to the third telephone call by the processor.

Another embodiment of the invention is a device effective to generate information relating to a telephone call. The device comprises a memory; and a processor in communication with the memory. The processor is effective to receive a request from a calling mobile telephone to establish a telephone call with a called telephone; establish a first telephone call between the processor and the calling mobile telephone over a cellular network; and establish a second telephone call between the processor and the called telephone. The processor is further effective to bridge the first and second telephone calls through the processor to produce a third telephone call; generate information relating to the third telephone call by the processor; and store the information in the memory.

Another embodiment of the invention is a system effective to generate information relating to a telephone call. The system comprises a mobile calling telephone; a called telephone; a memory; and a first processor in communication with the memory. The first processor is effective to receive a request from the calling mobile telephone to establish a telephone call with a called telephone; establish a first telephone call between the first processor and the calling mobile telephone over a cellular network; and establish a second telephone call between the first processor and the called telephone. The first processor is further effective to bridge the first and second telephone calls through the first processor to produce a third telephone call; generate information relating to the third telephone call; and send the information over a network to a second processor.

### BRIEF DESCRIPTION OF THE DRAWINGS

The drawings constitute a part of the specification and include exemplary embodiments of the present invention and illustrate various objects and features thereof.

FIG. 1 is a system drawing of a system in accordance with an embodiment of the invention.

FIG. 2 is a system drawing of a system in accordance with an embodiment of the invention.

FIG. 3 is a flow chart illustrating a process in accordance with an embodiment of the invention.

### DETAILED DESCRIPTION OF THE PREFERRED EMBODIMENT(S)

Various embodiments of the invention are described hereinafter with reference to the figures. Elements of like structures or function are represented with like reference numerals throughout the figures. The figures are only intended to facilitate the description of the invention or as a guide on the scope of the invention. In addition, an aspect described in conjunction with a particular embodiment of the invention is not necessarily limited to that embodiment and can be practiced in conjunction with any other embodiments of the invention.

The inventors have discovered that when individuals, such as salesmen, communicate using a mobile telephone, it is sometimes difficult for these individuals to keep track of a conversation with a customer. This difficulty to track the communication arises during the conversation and even after the conversation. As the calling telephone in these communications is a mobile telephone, the calling party frequently is not in an office where the calling party can easily record useful information regarding the communication. For example, after an hour long sales telephone call, a salesman may not always remember to log the hour long telephone conversation in his records. Moreover, the salesman may forget to record the contents of the conversation, to record any suggested follow up and/or a reminder to call the called party again in a defined period of time. As the salesman may not have made the telephone call from his office, he may not have ready access to a computer, pen and/or paper to record this information.

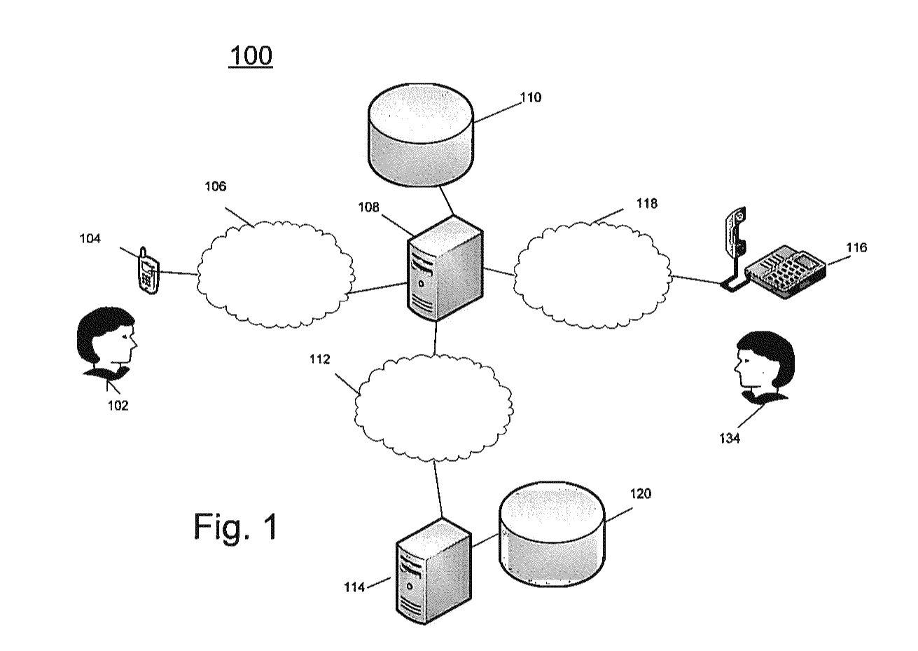

Referring to FIG. 1, there is shown a system 100 in accordance with an embodiment of the invention. As discussed in more detail below, system 100 may include a communications processor 108 in communication with a calling mobile telephone 104 over a network 106. Communication processor 108 is further in communication with a customer relationship processor 114 over a network 112. Customer relationship processor 114 is in communication with a memory 120. Communications processor 108 is also in communication with a memory 110 and with a called telephone 116 over a network 118.

In operation, a calling party 102 may make a request to establish a telephone call from calling mobile telephone 104 to called party 134 using called telephone 116. Calling mobile telephone 104 may send the request through communication processor 108 and may further request that communication processor 108 record the telephone call. Communication processor 108 may establish the telephone call between calling mobile telephone 104 and called telephone 116. Communication processor 108 may further record the telephone call and generate information relating to the telephone call. The information may be stored in memory 110 and/or sent to customer relationship processor 114 over network 112. Customer relationship processor 114 may store the information relating to the telephone call in memory 120.

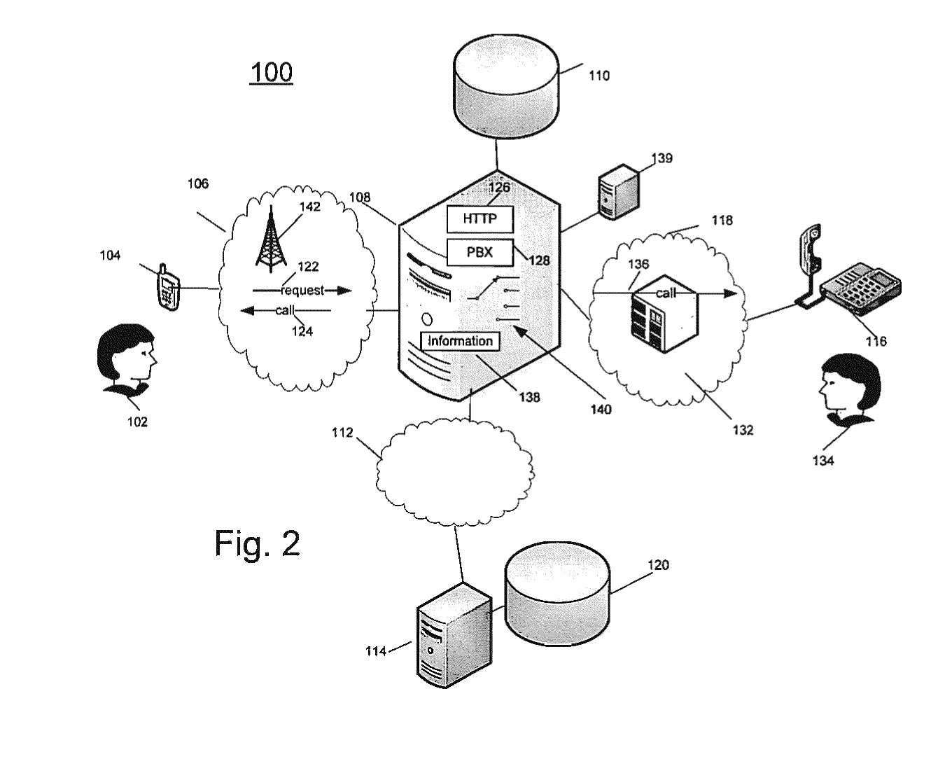

Referring to FIG. 2, there is shown more detail of system 100. As shown, calling party 102 may use calling mobile telephone 104 to make a request 122 to establish a telephone call with called telephone 116 and called party 134. Calling mobile telephone 104 may be, for example, a cellular phone, a smart phone, or any other mobile communication device that can communicate over a wireless cellular network. Request 122 may include an identification of calling party 102 and an identification of called party 134. Request 122 may be in a DTMF (dual tone multi-frequency signaling) format such as may be used in a request for a telephone call. For example, request 122 could be sent to a defined telephone number dialed by calling mobile telephone 104 using a cellular network 106. Request 122 may also be in a HTTP (hypertext transfer protocol) format sent over the Internet network 106 and may include a telephone number of calling party 102. Calling mobile telephone 104 may be configured to display a set of contacts to user 102 on a display. User 102 may select a contact on the display corresponding to called party 134 to generate request 122.

Network 106 may include, for example, a cellular network. Request 122 may be sent to communications processor 108 over the Internet (such as through a modem or wi-fi network) over a cellular network including a base station 142, or over the PBX network (such as in the DTMF example).

Request 122 may be received by communications processor 108. Communications processor 108 may include one or more of a PBX component 128 and/or a HTTP component 126 effective to handle request 122. Components 126 and 128 may be implemented in software and/or hardware. When request 122 is received by communications processor 108, communications processor 108 may authenticate an identification of calling party 102 against a list of subscribers that are part of system 100. The list may be stored in memory 110 and/or memory 120. Processor 108 may perform the authentication based on, for example, a phone number of mobile calling telephone 104 or based on another identifier of calling party 102.

When calling party 102 is authenticated, communications processor 108 may establish a telephone call between processor 108 and mobile calling telephone 104 as shown at “call” 124. Communications processor 108 may establish this telephone call by answering DTMF request 122. Alternatively, upon authentication of calling party 102, communications processor 108 may request a telephone call with calling mobile telephone 104 by sending a telephone number of mobile calling device 104 over network 106. Request 122 may be over a first network and call 124 may be over a second distinct network. As discussed above, the telephone number of mobile calling device 104 may be included in request 122.

Communications processor 108 may be also provided with a telephone number of called telephone 116. For example, communications processor 108 may be provided with the telephone number of called telephone 116 after establishing a telephone call with mobile calling device 104 (such as through DTMF communication) at call 124. Alternatively, communication processor 108 may be provided with the telephone number of called telephone 116 from a data request 122.

Communications processor 108 may now request and establish a telephone call 136 with called party phone 116 over network 118. Communications processor 108 may request and establish telephone call 136 over a corporate PBX 132 or through a communications service provider such as through VOIP (voice over internet protocol), SIP (Session Initiation Protocol), the H323 protocol or a similar protocol. PBX 132 may modify a calling 1D number of the request for telephone call 136 so that a telephone number relating to a company running PBX 132 may be sent to called party phone 116 in a caller ID field instead of a telephone number of calling mobile telephone 104. Prior to establishing telephone call 136, communications processor 108 may analyze call restriction rules stored in memory 110 and/or memory 120 to determine whether telephone call 136 should not be made to called party phone 116. For example, work team coordination rules may limit telephone calls to only those between a particular calling party 102 and a particular called party 134 at a particular time period.

As mentioned above, communications processor 108 may establish a first telephone call 124 with mobile calling phone 104. Communications processor 108 may establish a second telephone call 136 with called telephone 116. Communication processor 108 may now bridge 140 the first and second telephone calls so that a third telephone call 124-140-136 is established between calling mobile telephone 104 and called party telephone 116 through processor 108.

Communication processor 108 may store information 138 regarding third telephone call 124-140-136 between calling mobile telephone 104 and called party telephone 116. For example, communication server 108 may store the time duration, calling party identification, calling mobile telephone number, called party identification, telephone number, a voice recording of the conversation, etc. Communication processor 108 may further generate additional information 138 regarding third telephone call 124-140-136 such as a transcription of the third telephone call 124-140-136. For example, communication processor 108 may send data relating to telephone call 124-140-136 to a speech-to-text engine 139 and receive a transcription in response. Information 138 regarding third telephone call 124-140-136 may be stored in memory 110 and/or sent by communication processor 108 over network 112 to customer relationship processor 114. For example, a HTTP message may be sent to customer relationship processor 114 over the Internet. For example, an API (application programming interface) provided by customer relationship processor 114 may be used by communication processor 108 to send information 138 to customer relationship processor 114. Customer relationship processor 114 could be, for example, affiliated with an Internet based service such as salesforce.com.

Customer relationship processor 114 may link information 138 with called parties 134 in memory 120. For example, a sequence of calls to the same called party 134 may be linked. Queries may thereafter be issued to memory 120. For example, a user can search for content transcribed by communication processor 108.

Among other benefits, using a system in accordance with this disclosure, customer relationship records may be automatically updated after a telephone call originating from a mobile telephone. The automatic update minimizes users' efforts and helps ensure accurate and reliable call data. Mobile voice communications may be integrated with corporate customer relationship records. Reports may be generated to monitor sales team member activity. Telephone calls may be played back to analyze a quality of customer service and call content can be searched.

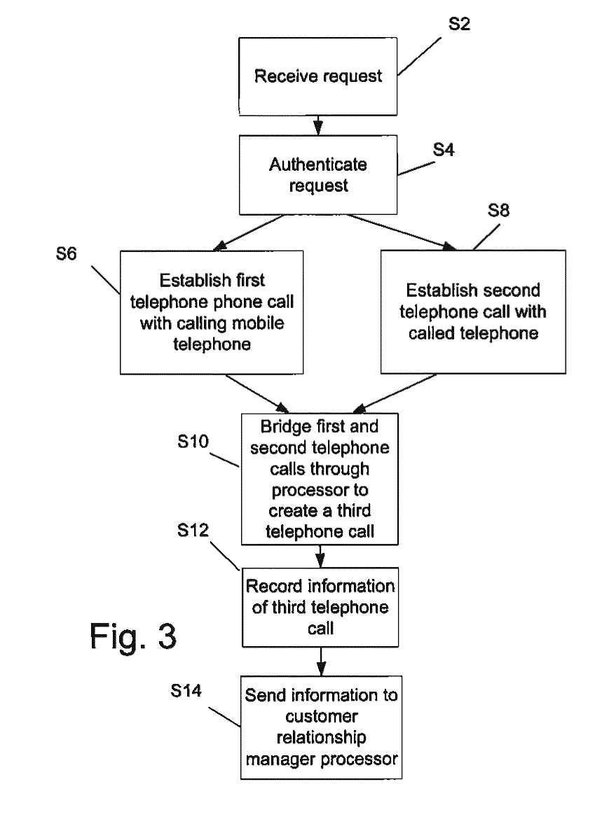

Referring to FIG. 3, there is shown a process which could be performed in accordance with the disclosure. The process of FIG. 3 could be implemented using, for example, system 100 discussed above. As shown, at a step S2, a communications processor may receive a request from a calling mobile telephone to establish a telephone call with a called telephone. At step S4, the communications processor may authenticate the request. For example, the communications processor could compare a telephone number of the calling mobile telephone with a list of telephone numbers of subscribers of the system.

After authentication, at step S6, the communications processor may establish a first telephone call with the calling mobile telephone. At step S8, the communications processor may also establish a second telephone call with the called telephone.

At step S10, the communications processor may bridge the first and second telephone calls to create a third telephone call through the communications processor. At step S12, the communications processor may record information relating to the third telephone call. At step S14, the communications processor may send the information to a customer relationship management processor.

While the invention has been described with reference to a number of exemplary embodiments, it will be understood by those skilled in the art that various changes can be made and equivalents can be substituted for elements thereof without departing from the scope of the invention. In addition, many modifications can be made to adapt a particular situation or material to the teachings of the invention without departing from essential scope thereof. Therefore, it is intended that the invention not be limited to any particular exemplary embodiment disclosed herein.

What is claimed is:

1. A method for generating information relating to a telephone call, the method comprising:
receiving a request, by a processor, from a calling mobile telephone to establish a telephone call with a called telephone;
establishing, by the processor, a first telephone call between the processor and the calling mobile telephone over a cellular network;
establishing, by the processor, a second telephone call between the processor and the called telephone;
bridging, by the processor, the first and second telephone calls through the processor to produce a third telephone call; and
generating information relating to the third telephone call by the processor.

2. The method as recited in claim 1, wherein the information includes a transcript of the third telephone call.

3. The method as recited in claim 1, wherein the processor is a first processor and the method further comprises sending the information by the first processor to a second processor over a network.

4. The method as recited in claim 3, further comprising sending the information by the first processor to the second processor using an API.

5. The method as recited in claim 3, further comprising linking the information to a caller party in communication with the called telephone.

6. The method as recited in claim 1, further comprising authenticating the request by the processor.

7. The method as recited in claim 1, wherein the information includes a voice recording of the third telephone call.

8. The method as recited in claim 1, wherein the request includes a telephone number of the called telephone.

9. The method as recited in claim 1, wherein establishing the second telephone call includes establishing the second telephone call through a corporate PBX.

10. The method as recited in claim 1, wherein the request is sent in a HTTP format.

11. The method as recited in claim 1, wherein the request includes an identification of calling party and an identification of a called party.

12. The method as recited in claim 1, further comprising prior to establishing the second telephone call, determining, by the processor, whether the second telephone call should be established based on restriction rules.

13. A device effective to generate information relating to a telephone call, the device comprising:
a memory;
a processor in communication with the memory, the processor effective to receive a request from a calling mobile telephone to establish a telephone call with a called telephone;
establish a first telephone call between the processor and the calling mobile telephone over a cellular network;
establish a second telephone call between the processor and the called telephone;
bridge the first and second telephone calls through the processor to produce a third telephone call;
generate information relating to the third telephone call by the processor; and
store the information in the memory.

14. The device as recited in claim 13, wherein the information includes a transcript of the third telephone call.

15. The device as recited in claim 11, wherein the information includes a voice recording of the third telephone call.

16. The device as recited in claim 11, wherein the processor is effective to establish the second telephone call through a corporate PBX.

17. A system effective to generate information relating to a telephone call, the system comprising:
a mobile calling telephone;
a called telephone;
a memory;
a first processor in communication with the memory, the first processor effective to
receive a request from the calling mobile telephone to establish a telephone call with a called telephone;
establish a first telephone call between the first processor and the calling mobile telephone over a cellular network;
establish a second telephone call between the first processor and the called telephone;
bridge the first and second telephone calls through the first processor to produce a third telephone call;
generate information relating to the third telephone call; and
send the information over a network to a second processor.

18. The system as recited in claim 17, wherein the information includes a voice recording of the third telephone call.

19. The system as recited in claim 17, wherein the information includes a transcript of the third telephone call.

20. The system recited in claim 17, wherein the processor is effective to establish the second telephone call through a corporate PBX.
